(19) United States
(12) Patent Application Publication
(10) Pub. No.: US 2018/0047302 A1
(43) Pub. Date: Feb. 15, 2018

(54) Crumbling Caloric Stockpile Tracker

(71) Applicant: Terri Michele Fuller, Bloomfield Township, MI (US)

(72) Inventor: Terri Michele Fuller, Bloomfield Township, MI (US)

(21) Appl. No.: 15/232,686

(22) Filed: Aug. 9, 2016

(51) Int. Cl. G09B 19/00; G09B 5/02

(52) U.S. Cl. CPC G09B 19/0092; G09B 5/02

(57) ABSTRACT

A fitness system may include a mobile device configured to, in response to receiving a caloric depletion rate based on data received from an activity tracker and a current food article having a caloric value, display a depiction of the food article defined by a difference between the caloric value and an aggregated caloric depletion based on the caloric depletion rate. The caloric depletion rate may include a basal metabolic rate. The depiction may further include an estimated aggregate caloric depletion region. The region may define a first subregion indicative of an increased caloric depletion rate. The region may define a second subregion indicative of a maintained caloric depletion rate. The data may be the caloric depletion rate. The activity tracker may be a heart rate monitor.

### TECHNICAL FIELD

The present disclosure relates to fitness devices and equipment, and more specifically to visual representations of working off calories of a food article.

### BACKGROUND

Health conscious consumers may occasionally eat unhealthy, dubious food articles. Exercise may be required to prevent the treat from being stored as fat. However, the consumer may have limited knowledge of the calories burned during exercise or the number of calories in the food article. This leaves the consumer unsure how much exercise is required to burn off the calories of the treat.

### SUMMARY

A fitness system may include a mobile device configured to, in response to receiving a caloric depletion rate based on data received from an activity tracker and a current food article having a caloric value, display a depiction of the food article defined by a difference between the caloric value and an aggregated caloric depletion based on the caloric depletion rate. The caloric depletion rate may include a basal metabolic rate. The depiction may further include an estimated aggregate caloric depletion region. The region may define a first subregion indicative of an increased caloric depletion rate. The region may define a second subregion indicative of a maintained caloric depletion rate. The data may be the caloric depletion rate. The activity tracker may be a heart rate monitor. The activity tracker may be a pedometer. The activity tracker and mobile device may be a unitary device. The caloric value may be obtained from a food database. The aggregated caloric depletion may be equal to a product of the caloric depletion rate and a time period. The time period may begin when the article is consumed.

### BRIEF DESCRIPTION OF THE DRAWINGS

FIG. 1 depicts a fitness system having a mobile device and plurality of activity trackers;

FIG. 2 depicts a computer for a mobile device having a central processing unit, connected by a data bus network to a member for storing machine instructions and a display;

FIG. 3 depicts a food article having an aggregated caloric depletion region;

FIG. 4A depicts a food article having predetermined regions removed indicative of an aggregated caloric depletion;

FIG. 4B depicts a food article having additional predetermined regions removed indicative of an aggregated caloric depletion

FIG. 4C depicts a food article having additional predetermined regions removed indicative of an aggregated caloric depletion;

FIG. 5 is a flow diagram for displaying a residual caloric content;

FIG. 6 is a flow diagram for displaying a residual caloric content;

FIG. 7A depicts an introduction screen;

FIG. 7B depicts a user input screen; and

FIG. 7C depicts a food article selection screen.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A nutrition application may allow a user to enter information descriptive of food articles that the user has consumed or intends to consume. The application may retrieve nutritional information corresponding to the entered food articles, and use the retrieved information to track the user's nutritional or caloric intake. In an example, the application may compare the nutritional information against caloric or other goals that the user has for the day. The application may use the comparison to indicate how many calories remain for the day within the user's daily goals.

To aid in determining the amount of allowable calories for the day, the application may be programmed to calculate a basal metabolic rate or a caloric burn rate of the consumer. This calculation may be based on height, weight, steps walked, and a general activity level entered by the user. The application may use the calculation to specify additional calories that can be consumed within the user's daily goal according to the computed burn rate.

Some users may wish to offset calories of a food item by adding exercise. However, the user may be unaware of his or her current activity level to be able to accurately offset the caloric consumption. Thus, it may be difficult for the user to know how much additional exercise would be sufficient to burn the calories necessary to consume the desired food item.

A device, such as a mobile phone or a treadmill, may display a visual representation of a food article consumed, or intended to be consumed, by a user. The visual representation may include an image or other representation of the food article, with a region removed from the article representing an amount of calories burned off by the user. In an example, the amount of calories being burned off may be computed based on basal metabolic rate in combination with data received from a fitness tracker device. As more calories are burned off, the representation of the food article may melt, crumble, fall away, or otherwise disappear. Accordingly, the crumbling away of the food article may give the user a real-time visual representation of the remaining effort required to offset the calories of the food article.

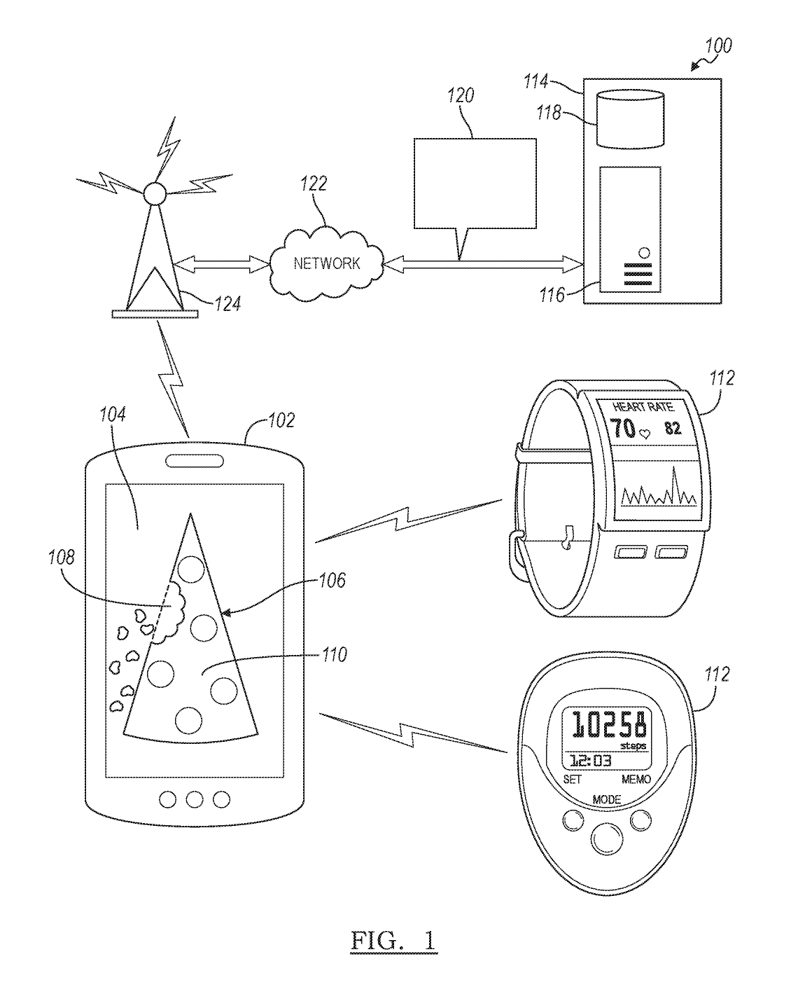

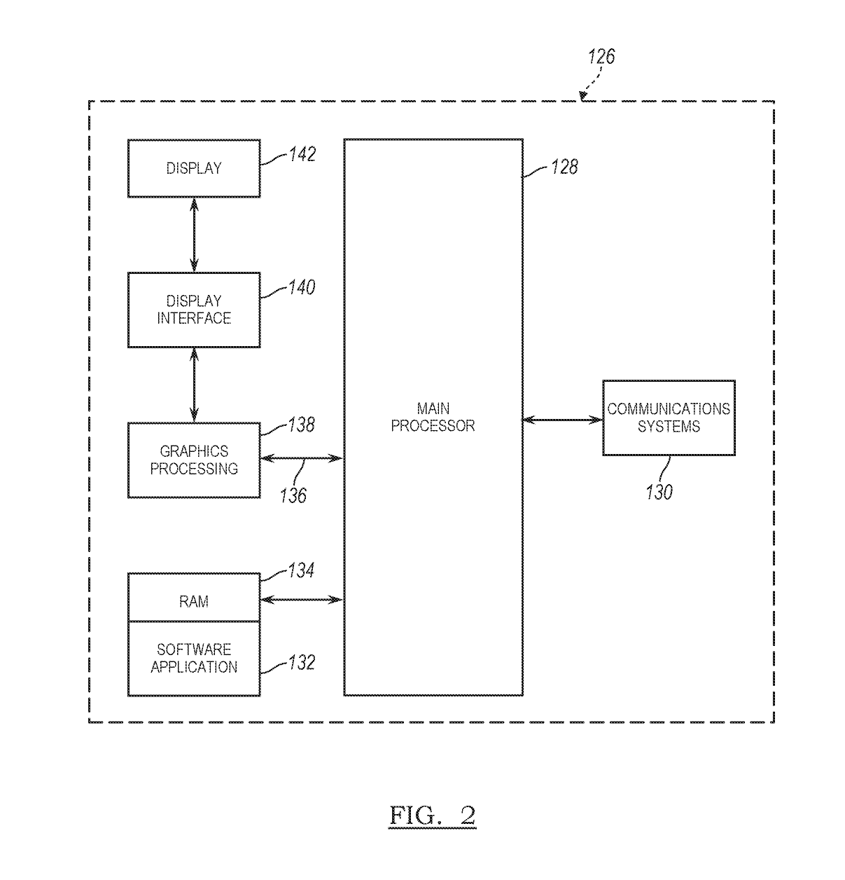

Referring to FIG. 1, a real-time fitness system 100 is shown. The fitness system 100 includes a mobile device 102 having a display 104 illustrating a visual representation of a food article 106 and a visual representation of an aggregated caloric depletion 108 representative of a portion of the food article 106 that has been metabolized. To determine the calories of the food article 106, the mobile device 102 accesses a food information database 114 maintaining nutritional information 120 of various food articles 106. To determine the aggregated caloric depletion 108, the mobile device 102 receives data from at least one activity tracker 112. The mobile device 102 may be configured to access the food information database 114 over a network 122 via combination of radio towers 124 or other communications systems. The database 114 may additionally include images or other visual representations of the food articles 106 to aid in illustrating the food article 106 in the display 104. As more calories are burned, the aggregated caloric depletion 108 causes the visual representation of the food article 106 to melt, crumble, fall away, or otherwise disappear. Thus, the mobile device 102 provides the user with a real-time visual representation of the remaining effort required to offset the calories of the food article 106. It should be noted that the system 100 illustrated in FIG. 1 is only an example, and systems 100 having more, fewer, or differently divided or located elements may be used. In an example, the mobile device 102, activity tracker 112, or database 114 may be a unitary device or separate devices.

The mobile device 102 may be any type of transportable computer system or system that configured to perform computing operations. For example, the mobile device 102 may be a smart phone or cellular device having network 122 communications and internet access. As some other possibilities, the mobile device 102 may be a tablet computer or a desktop computer. In further examples, the functionality described herein in terms of the mobile device 102 may be implemented in a controller of a treadmill or other item of fitness equipment, e.g., to provide the visual representation 110 of the food article 106 to the operator of the fitness equipment.

Referring back to FIG. 1, the activity tracker 112 may be any type of device capable of gathering biological data and/or calculating a caloric burn rate from gathered data. For example, the activity tracker 112 may be a Fitbit® device provide by Fitbit Inc. of San Francisco, Calif., a pedometer, or a watch or other wearable having activity level measuring functionality. The activity tracker 112 may monitor various biological inputs, such as heart rate and/or pulse rate, to determine the activity level and/or energy expenditure of the wearer. The activity tracker 112 may send to the mobile device 102 data indicative of the monitoring, such as raw pulse or heart rate data and/or caloric burn rate data computed by the activity tracker 112 for the wearer. As some specific examples, the activity tracker 112 may send information to the mobile device 102 indicative of steps taken, miles traveled, heart rate, weights lifted, or relative motion levels. Relative motion levels may include sensing techniques that include accelerometers or motion detectors to determine movement. In some embodiments, the activity tracker 112 may be contained within the mobile device 102 and the two devices may operate as a unit. In other examples, the activity tracker 112 and mobile device 102 may be discrete devices. For instance, when embodied as discrete devices, the mobile device 102 may be paired with and connected to the activity tracker 112 to receive information from the activity tracker 112. This connection may occur over any wired or wireless medium, such as via a BLUETOOTH or short-range wireless connection or via a universal serial bus (USB) or other wired connection.

The food article 106 refers to an item of food intended to be eaten or that has been eaten by the user. A consumer may input information specifying the food article 106 through a user interface of the mobile device 102. Alternatively, the consumer may send the information regarding the food article 106 from another device (e.g., the activity tracker 112) to the mobile device 102. Entering the information may include one or more of scanning a barcode on the food article 106, taking a picture of the food article 106, typing in a name of the food article, indicating an amount of the food article 106 (e.g., weight, volume, units, etc.), or specifying calories or other nutritional information 120 corresponding to the food article 106.

The nutritional information 120 may include caloric information of the food article 106 or information that can be used to derive the caloric information of the food article 106. In an example, the nutritional information 120 may specify calories of the food article 106 per portion size. The nutritional information 120 may include other nutritional facts regarding the food article 106, such as the amount of fat, carbohydrates, protein, sodium included within the food article 106.

The database 114 may include caloric information and other pertinent nutritional information 120 indexed to identifiers of the food articles 106. For instance, the database 114 may include nutritional information 120 indexed to bar codes or names of food articles 106. The mobile device 102 may be configured to query the database 114 using the information specifying a food article 106 to retrieve the nutritional information 120 for the food article 106. In some cases, the database 114 may be local to the mobile device 102, e.g., stored to a memory of the mobile device 102. In other examples, the database 114 may be remote from the mobile device 102 and may be accessed by the mobile device 102 over a network. In an example, the database 114 may be maintained by a governmental organization, such as the United States Department of Agriculture (USDA). In another example, the database 114 may be maintained by a company or other organization, such as the food item database 114 maintained by MyFitnessPal, Inc.

In some examples, the database 114 (or another database accessible to the mobile device 102) may be configured to maintain images of food articles 106. Thus, the mobile device 102 may also query the database 114 to retrieve images of the food articles 106 having been entered by the user. In an example, a donut may be entered as having been eaten by the user. The mobile device 102 may access the database 114 to retrieve the nutritional information 120 associated with the donut (e.g., which may indicate a food article 106 having sixty calories), and may also retrieve include an image of the donut for display to the user.

In some examples, the database 114 may additionally track consumption of the user over time. In an example, as the user enters information indicative of the food articles 106 consumed or intended to be consumed, the database 114 may maintain records of those food articles 106 in association with an account of the user mobile device 102.

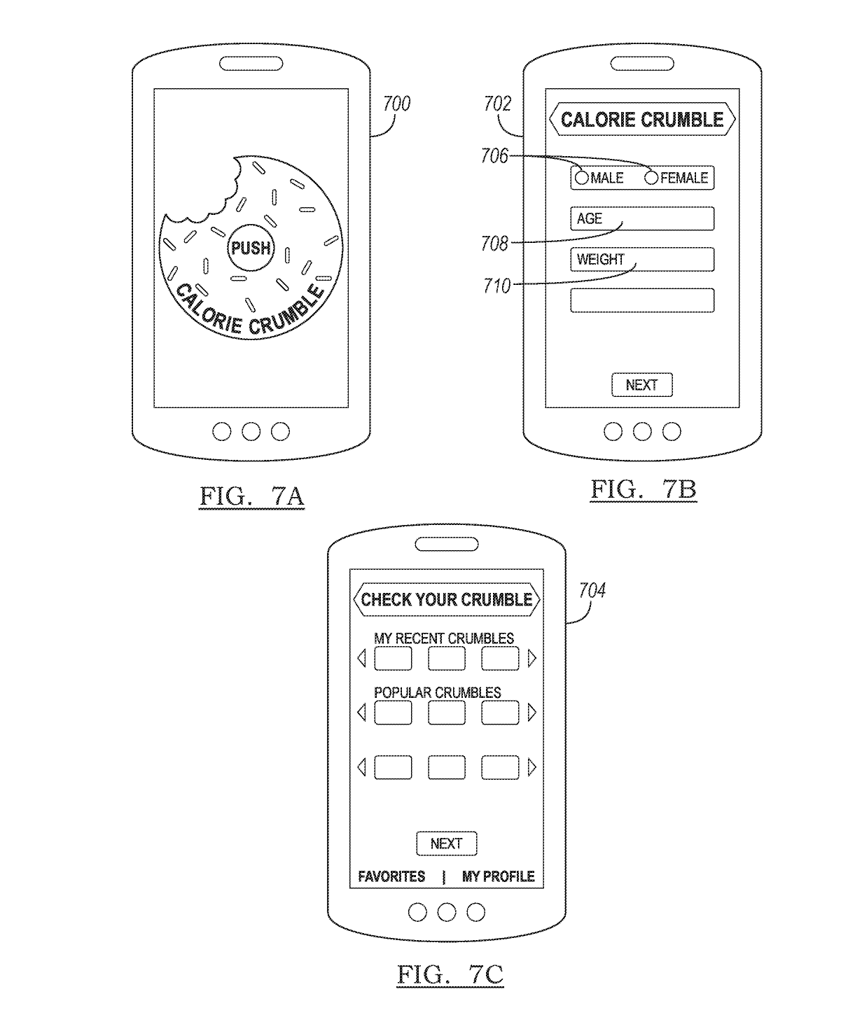

The user setting information 706, 708, 710, as shown in FIGS. 7A-C, may include information used to compute the caloric depletion rate of the user. The caloric depletion rate may include a basal metabolic rate indicative of the resting caloric burn of the user, and a variable rate based on the activity level of the user.

The mobile device 102 may collect and maintain the user setting information 706, 708, 710. For instance, to aid in the calculation of the basal metabolic rate of the user, the user may enter the setting information 706, 708, 710 using a user interface of the mobile device 102. The setting information 706, 708, 710 may include, as some examples, information indicative of the height, weight, age, gender, activity level, or other factors of the user pertinent to the calculation of the basal metabolic rate. In an example, using the setting information 706, 708, 710 the mobile device 102 may calculate a user-specific basal metabolic rate using the setting information 706, 708, 710 according to the equations 1 or 2 as follows.

BMR_{MEN}=(10×weight (kg))+(6.25×height (cm))—(5×age (years))+5 (1)

BMR_{WOMEN}=(10×weight (kg))+(6.25×height (cm))−(5×age (years))−161 (2)

The user setting information 706, 708, 710 may further be used to interpret information received from the activity tracker 112 to allow for calculation of a caloric burn rate based on the user's activity. For example, the activity tracker 112 may determine a current heart rate of the user. The activity tracker 112 may send the heart rate information to the mobile device 102. Using the received heart rate information, the mobile device 102 may calculate the caloric burn rate based on the heart rate, age, height, weight, and gender of the user. In at least one example, the activity tracker 112 and/or mobile device 102 may determine the caloric burn rate or calories burned based on the activity level and mode of user. The mobile device 102 may use that information to determine the aggregated caloric depletion (ACD) 108. For example, the aggregated caloric depletion 108 is shown in equations 3 and 4 below for an activity tracker that monitors heart rate.

ACD_{MEN}=((−55+(0.6×HR)+(0.19×W)+(0.2×A))/4.1)×60×T (3)

ACD_{MEN}=Female:((−20.4+(0.4×HR)−(0.1×W)+(0.07×A))/4.18)×60×T (4)

where:

HR=Heart rate (in beats/minute)

W=Weight (in kilograms)

A=Age (in years)

T=Exercise duration time (in hours)

Footsteps may also be used to calculate the ACD. For example, the aggregated caloric depletion 108 is shown in equation 5 below for an activity tracker that monitors miles walked.

CB=[0.021×KPH3−0.17×KPH2+0.87×KPH+1.45]×WKG×T (5)

where:

CB=Calorie burn (in calories)

KPH=Walking speed (in kilometers per hour)

WKG=Weight (in kilograms)

T=Time (in hours)

Using the aggregated caloric depletion 108, the mobile device 102 may be configured to provide on the display 104 a real-time indication of the metabolized calories of the food article 106. For instance, the mobile device 102 may display a graphical representation 302 of the food article 106. The graphical representation 302 may include a removed region based on the aggregated caloric depletion 108 indicative of the user's progress towards metabolizing the food article 106. Example graphical representations 302 are discussed in further detail below.

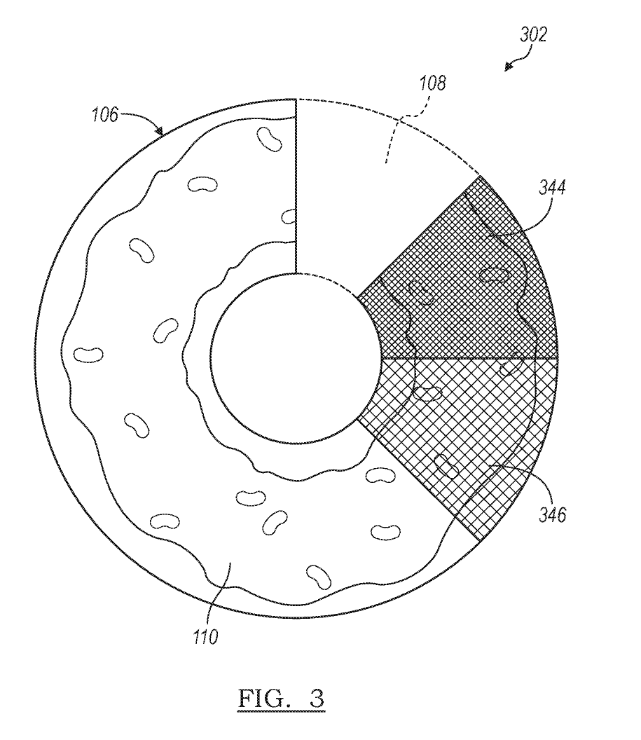

Referring to FIG. 3, one example graphical representation 302 of a food article 106 is shown. In an example, the graphical representation 302 may be provided by the mobile device 102 to the display 104 of the mobile device 102. As shown in the illustrated example, the graphical representation 302 is of a donut food article 106, although this is merely one example. The graphical representation 302 is illustrated as having a removed section equal to an aggregated caloric depletion 108. The region of the aggregated caloric depletion 108 is determined by the mobile device 102 based on the basal metabolic rate of the user and the caloric depletion rate of the user. The graphical representation 302 includes an estimated aggregate caloric depletion 108 region. The estimated aggregate caloric depletion 108 region includes a first subregion 346 and a second subregion 344. The first subregion 346 indicates a caloric depletion at a rate greater than the caloric depletion rate. The second subregion 344 indicates an estimated aggregate caloric depletion based on the current caloric depletion rate. The remaining, residual calorie count visual representation 110 is shown.

As the user works off the food article 106, the graphical representation 302 may begin to disappear. For instance, the mobile device 102 may alter the graphical representation 302 of the food article 106 by removing or fading of a portion of the image of the food article 106 proportional to the calories consumed. Depending on the granularity of the information received, the system may fade each pixel as it is burned off. The pixel burned may be determined based on a predetermined priority or animation order. As some example animations, the pixels may fade in a clock fashion or they may fade in particular food article 106 segments.

In an example, predetermined cutouts or bites 108 may be used to subtract the caloric content of the image when caloric thresholds are reached. For instance, a 10% caloric threshold may be associated with a particular cutout designed to represent 10% of the food article 106. The cutout may have jagged edges to represent the residual caloric content of the food article 106 as eaten away. As the user burns more calories, additional chunks of the food article 106 are removed until the food article is completely consumed.

Various other visualizations of consumption of the food article 106 may be used. In another example graphical representation 302, the pixels may be randomly faded similar to increasing the opacity of the image such that it is blended with a background color. Accordingly, the graphical representation 302 of the food article 106 is seemingly melted away as exercise is performed. Continuing with the donut example, if five calories are burned, the mobile device 102 may blend a portion of the pixels or groups of pixels, which may correspond to the one of the aforementioned cutouts or bites. If 10% of the calories have been burned, the controller may blend every tenth pixel. Different methods may be used to blend or fade the image of the donut into the background color. Blending may occur for a subset of the pixels representing the food article 106 or all of the pixels.

In another example visualization of consumption of the food article 106, the mobile device 102 may fade the graphical representation 302 in a clockwise or counterclockwise fashion. The mobile device 102 may select each of the pixels on a vector starting at twelve o'clock. The mobile device 102 may begin to fade each of the pixels on a rotating vector from twelve o'clock in a clockwise fashion. Continuing with the above example, the mobile device 102 may fade 1/12^{th} of the graphical representation 302 when five calories are burned. The position of the fade vector may be equal to one o'clock.

Some food articles 106 may have an irregular or jagged perimeter. In such examples, the mobile device 102 may be configured to treat the perimeter of the food article 106 as a simple geometric shape. For example, a donut may be treated as having a circular perimeter to simply calculation. In some examples, the database 114 may associate food articles 106 with geometric shapes, and the mobile device 102 may identify the geometric shape of the food article 106 according to information retrieved from the database 114. The shape information retrieved from the database 114 may additionally or alternatively include predefined burn patterns that may be used to crumble the food article 106. As the user progressively burns off calories, the food article 106 may crumble in predefined burn patterns corresponding to the retrieved shape information. These predefined burn patterns may be cutouts, bites, pixel sections, or pie-shaped sections.

The food article 106 may also include separate regions to indicate an anticipated or estimated caloric depletion at a given activity level. For example, the mobile device 102 may display the graphical representation 302 of the food article 106 using a different color, discolored section, overlay, or color alteration for a region of the graphical representation 302 that is expended to be burned off by the user within a set period of time. This expected burn may be based on extrapolating a caloric consumption trend according to the current burn level of the user. The set period of time may be a predefined number of minutes, such 30 minutes, or 60 minutes depending on user preference. The estimated caloric depletion region may have different regions for each time level estimated. For example, the food article 106 may include indicia having both a 30 minute or hour estimated depletion region. The indicia may include a region for a stretch goal of exertion. For example, the cookie may be estimated to crumble at the same exertion or activity level in 30 minutes. The indicia may include a region displayed for an increased level of exertion as well.

A representation of the food article 106 may be displayed on the display 104 of the mobile device 102. In an example, the representation may be a caricature or idealized version of the food article 106. In another example, the representation of the food article 106 may include a photographic image of a canonical or representative version of the food article 106. The food article 106 may also be represented on cards so that each of the cards can be discarded when the caloric content of the card is exercised away. For example, as a user consumes food articles 106 throughout the day, the user may accumulate food articles 106 in a queue. As each food article 106 is exercised off, the corresponding food articles 106 may be discarded. The user may also shuffle articles in the queue to psychologically entice a workout.

The real-time indicia of the original caloric content of each food article 106 may be defined by regions. The regions may represent the residual caloric content of the food article 106 and a spent caloric content of the food article 106. The spent caloric content region may be based on the metabolic rate and caloric burn rate of the user. The regions may be defined by a specific number of pixels on the display that is equal to the calories consumed or burned. Meaning, each pixel on the display has a calculable equivalent caloric value based on the calories in the food article 106 and the space occupied by the food article 106. The display may include graphics processing to convert the food article 106 image received from the database 114 such that the image fits on the display. The processing may be required to recognize the number of pixels occupied by the food article 106 image. The mobile device 102 may receive from the display the number of pixels occupied by the device 102 and calculate the calories per pixel. With this information available, the mobile device 102 can begin to crumble the food article 106 by pixel at the basal metabolic rate, the caloric burn rate, or combination thereof. The residual caloric content may be defined by the original caloric content subtracted by a product of the caloric burn rate and a period of time. The period may be shorted to provide seemingly real-time subtraction of the calories expended by the basal metabolic rate and the calories burned during exercise.

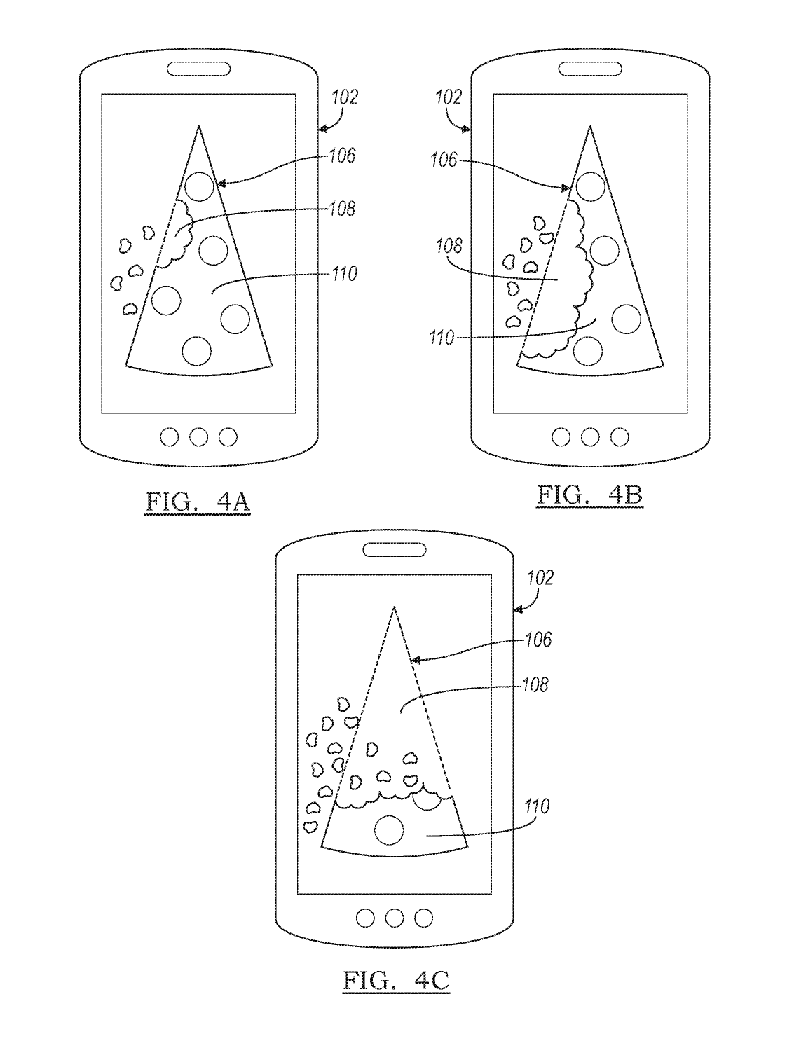

FIGS. 4A-C depict a slice of pizza being removed over time as the user exercises. In each of FIGS. 4A-C, a food article 106 is shown having an aggregated caloric depletion 108. The remaining, residual calorie count visual representation 110 is also shown. The combination of the regions 108 and 110 represents the total calories of the food article 106. Only a minor portion is consumed in the FIG. 4A, as evidenced by the small aggregated caloric depletion 108 region. In FIG. 4B, the aggregated caloric depletion 108 region is larger, signifying that additional calories have been consumed (i.e., greater aggregated caloric depletion 108). The area of the aggregated caloric depletion 108 region may accordingly increase proportional to the amount of calories having been consumed. In FIG. 4C, the aggregated caloric depletion 108 region occupies most of the area of the food article 106, indicating that most of the food article 106 has been consumed.

In the examples of FIGS. 4A-4C the aggregated caloric depletion 108 of the food article 106 is indicated using predetermined regions or cutouts. When the aggregated caloric depletion 108 reaches a particular threshold related to the size of the food article 106 on the display 104, the food article 106 image is removed by a predetermined amount using the predefined cutouts.

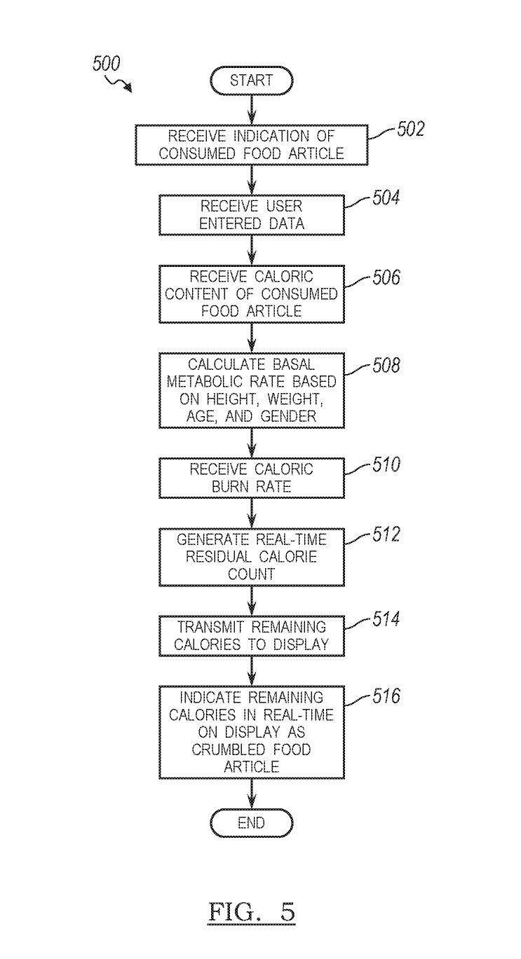

Referring to FIG. 5, a flow chart 500 is shown. Although shown with a start and end, the flow chart 500 may run as a continuous process. In step 502, the mobile device 102 may receive indication of a consumed food article 106. The indication may be received from the user interface or display, or the indication may be sent from a separate computer or server. In step 504, the mobile device 102 may receive user-entered data. The data may be the user's height, weight, age, or gender. In step 506, the mobile device 102 may receive the caloric content of the consumed food article 106. In step 508, the mobile device 102 may calculate the basal metabolic rate based on height, weight, age, and gender. In step 510, the mobile device 102 may calculate or receive the caloric burn rate. The caloric burn rate may be calculated from raw data received from the activity tracker 112 or received from the activity tracker 112. In step 512, the mobile device 102 generates a real-time residual calorie count based on the caloric burn rate and the caloric content of the consumed food article 106. In step 514, the remaining calories are transmitted to the display for indication to a user. The transmittal may include removed bites or cutouts of the crumbled calories. In step 516, the remaining calories may be indicated in real-time on the display as the crumbed food article 106.

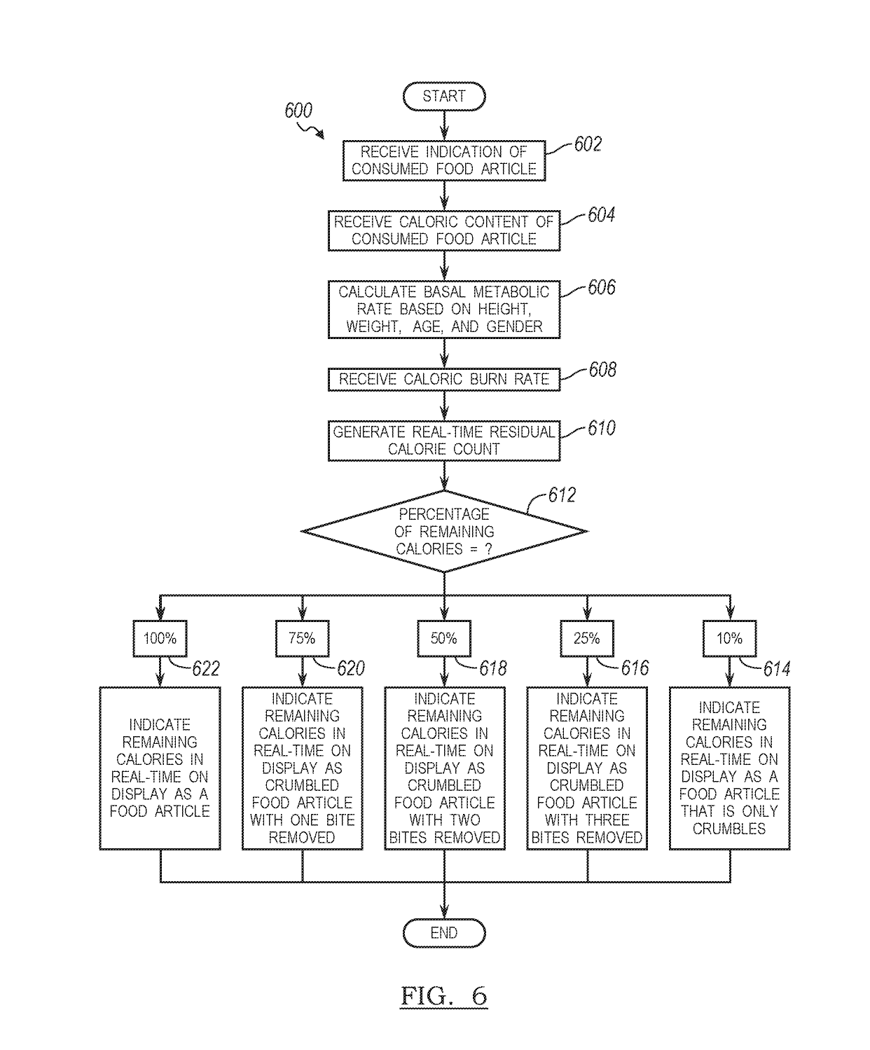

Now referring to FIG. 6, a flow chart 600 is shown. Although shown with a start and end, the flow chart 600 may run as a continuous process. In step 602, the mobile device 102 may receive indication of a consumed food article 106. The indication may be received from the user interface or display, or the indication may be sent from a separate computer or server. In step 604, the mobile device 102 may receive the caloric content of the consumed food article 106. In step 606, the mobile device 102 may calculate the basal metabolic rate based on height, weight, age, and gender. In step 608, the mobile device 102 may calculate or receive the caloric burn rate. The caloric burn rate may be calculated from raw data received from the activity tracker 112 or received from the activity tracker 112. In step 610, the mobile device 102 generates a real-time residual calorie count based on the caloric burn rate and the caloric content of the consumed food article 106. In step 612, the mobile device 102 determines the percentage of remaining calories in the consumed food article 106. In each of the cases 314, 316, 318, 320, 322 the mobile device 102 displays a predetermined food article 106 with the generated calorie count to indicate to the user the remaining calories. The food article 106 may have removed bites or cutouts that indicate the calories burned during exercise or due to the basal metabolic rate.

Now referring to FIGS. 7A-C, a set of screen shots for the application is shown. FIG. 7A depicts an introductory image 700 featuring the calorie crumble logo. In an example, a user may press the logo to begin using the application. Or, the logo may display for a predefined amount of time before proceeding into the application.

FIG. 7B depicts a user input screen 702 for entering personal information required to compute the basal metabolic rate. As shown, the user may enter setting information 706, 708, 710 with personal information related to height, weight, gender, and age. This information may be used by the application to compute the user-specific basal metabolic rate as discussed in detail above.

FIG. 7C depicts a selection screen 704 from which a user may select a food article 106 or placeholder food article 106 to begin the calorie crumble. In other examples (not shown), the user may select a number of calories for a card to be used to perform the calorie crumble. In an example, responsive to selection of a food article 106 from the selection screen 704, the application may proceed to a display of a graphical representation 302 of the food article 106 for the calorie crumble, examples of which are described above with respect to FIGS. 3 and 4A-4C.

Computing devices described herein generally include computer-executable instructions where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A fitness system comprising:
a mobile device, including a processor and a display and configured to communicate with an activity tracker, programmed to:
receive information indicative of a caloric burn rate from the activity tracker;
update an aggregated caloric depletion indicative of a cumulative count of burned calories according to the caloric burn rate; and
display a graphical representation of a food article on the display, the food article having a defined number of calories, the graphical representation including a removed region to indicate progress towards metabolizing the food article, the removed region being illustrated proportional in size to the aggregated caloric depletion compared to the defined number of calories of the food article.

2. The fitness system of claim 1, wherein the mobile device is further configured to:
receive input indicative of the food article having been consumed or to be consumed; and
query a food database based on the input to retrieve the defined number of calories.

3. The fitness system of claim 2, wherein the mobile device is further configured to retrieve the graphical representation of the food article from the food database.

4. The fitness system of claim 1, wherein the food article is a card representative of a predefined number of calories.

5. The fitness system of claim 4, wherein the mobile device is operable to enable a user to shuffle a plurality of cards including the card, each of the plurality of cards representative of calories of a different food article.

6. The fitness system of claim 1, wherein the activity tracker is a heart rate monitor.

7. The fitness system of claim 1, wherein the activity tracker and the mobile device are unitary.

8. The fitness system of claim 7, wherein the activity tracker and mobile device are housed in exercise equipment.

9. A method comprising:
displaying by a processor real-time indicia of an original caloric content of a food article defined by regions representative of a residual caloric content of the food article and a spent caloric content of the food article such that a sum of the residual caloric content and the spent caloric content is the original caloric content of the food article, wherein each caloric component of the indicia is an equal proportion of the original caloric content.

10. The method of claim 9, wherein the spent caloric content is equal to a caloric depletion rate based over a period originating during selection of the food article.

11. The method of claim 10, wherein the caloric depletion rate is based on data received from an activity tracker.

12. A fitness system comprising:
a mobile device configured to, in response to receiving a caloric depletion rate based on data received from an activity tracker and a current food article having a caloric value, display a depiction of the food article defined by a difference between the caloric value and an aggregated caloric depletion based on the caloric depletion rate.

13. The fitness system of claim 12, wherein the caloric depletion rate includes a basal metabolic rate.

14. The fitness system of claim 13, wherein the depiction further includes an estimated aggregate caloric depletion region.

15. The fitness system of claim 14, wherein the region defines a first subregion indicative of an increased caloric depletion rate.

16. The fitness system of claim 15, wherein the region defines a second subregion indicative of a maintained caloric depletion rate.

17. The fitness system of claim 12, wherein the data is the caloric depletion rate.

18. The fitness system of claim 12, wherein the activity tracker is a heart rate monitor.

19. The fitness system of claim 12, wherein the caloric value is obtained from a food database.

20. The fitness system of claim 12, wherein the aggregated caloric depletion is equal to a product of the caloric depletion rate and a time period.

21. The fitness system of claim 20, wherein the time period begins when the article is consumed.
